(19) United States
(12) Patent Application Publication
(10) Pub. No.: US 2008/0249221 A1
(43) Pub. Date: Oct. 9, 2008

(54) POLYMERIC ADHESIVE INCLUDING NANOPARTICLE FILLER

(75) Inventors: Robert W. Corkery, Stockholm (SE); Cathy Fleischer, Rochester, NY (US); Robert C. Daly, Greece, NY (US)

Correspondence Address: BASCH & NICKERSON LLP, 1777 PENFIELD ROAD, PENFIELD, NY, 14526, US

(73) Assignee: NaturalNano Research, Inc., Pittsford, NY (US)

(21) Appl. No.: 11/697,490

(22) Filed: Apr. 6, 2007

(51) Int. Cl. C08K 3/00; B05D 3/02

(52) U.S. Cl. 524/404; 427/387; 524/410; 524/418; 524/428; 524/430; 524/445

(57) ABSTRACT

Disclosed is a novel polymeric nanoparticle adhesive composite including a nanoparticle filler and method for the production thereof. More particularly, the disclosure describes the use of nanoparticle fillers, including a novel halloysite nanoparticle filler which utilizes generally cylindrical or tubular nanoparticles (e.g. rolled scroll-like shape). The filler is effectively employed in a polymer nanoparticle adhesive composite, containing the halloysite nanoparticle or other equivalent naturally occurring nanotubular filler, in which the advantages of the nanoparticle filler are provided (e.g., reinforcement, flame retardant, etc.) while maintaining or improving mechanical performance of the adhesive composite (e.g., adhesive strength and tack)

### CROSS-REFERENCE TO RELATED APPLICATION

U.S. patent application ______, for “IMPROVED POLYMERIC COATINGS INCLUDING NANOPARTICLE FILLER,” by R. Corkery et al., filed concurrently herewith, is cross-referenced and hereby incorporated by reference in its entirety.

The present disclosure relates to a novel polymeric adhesive including a nanoparticle filler. More particularly, the present disclosure provides a novel halloysite nanoparticle filler which has the general shape of a cylinder or a rolled scroll, in which the diameter of the cylinder is less than about 500 nm, and a polymer adhesive composite, containing the halloysite nanoparticle or other equivalent naturally occurring nanotubular filler, in which the advantages of the nanoparticle filler are provided (e.g., reinforcement, flame retardant, etc.) while maintaining or improving mechanical performance of the adhesive composite (e.g., adhesive strength and tack).

### BACKGROUND AND SUMMARY

Polymeric adhesives are commonly used in man-made materials for construction, consumer products (i.e., bandages, labels), and the like. Filler particles may be introduced into such adhesives, for example when used as coatings, to control mechanical, thermal, optical, and/or physical properties. A polymer adhesive composite includes at least one polymer matrix or material in combination with at least one particulate filler material. The polymer matrix material may be any of a number of polymers including thermoplastics such as polyurethanes, vinyl polymers, and the like, thermosets, and elastomers. Also included in the range of polymers that may be used are—biopolymer adhesives, including polysaccharides (e.g. starch), polypeptides and proteins such as caseins, gelatin, collagens, mucins, wheat gluten, etc. Some of the most common nanoparticle fillers are nanoclays, carbon nanotubes, and metal oxide nanoparticles such as Zinc Oxide (ZnO), Titanium Dioxide (TiO2), and Zirconium (Zero).

Today, polymer adhesive composite coating materials can be found in various products such as automobiles, building materials, labels, household products, and food packaging. Adhesive composites offer the potential of combining materials to produce those having properties not often available using traditional raw materials alone, such as tack, mechanical strength, self-healing properties, and the like. It will be further appreciated that embodiments and materials disclosed herein may also be applicable for use as pacifiers (i.e., substance(s) added to resins to improve the initial and extended tack range of the adhesive). And, it is further contemplated that embodiments set forth herein may further include pacifiers added thereto.

One particular class of composite has potential for obtaining optimal polymer adhesives—polymer clay Nan composites, particularly including coatings. Nan composites generally include one or several types of nana-scale particles dispersed within a polymer matrix. The benefits of nanoparticles are derived from the surface area interactions of the nanoparticles with the polymer matrix. The nature of this interaction allows for beneficial property improvements, sometimes using fillers at very low loading levels, often as low as about 1 to 10 weight percent. The possibility of using lower loading levels reduces concerns relative to a reduction of tack often resulting from the addition of filler to the adhesive or coating. The lower loading levels also increase the potential for homogeneous dispersion of the filler within the composite matrix.

An advantage of the use of Nan composite adhesives is the ability to obtain the mechanical properties of the Nan composite while maintaining tack properties. The implications of this discovery extend the possibility of creating multifunctional composite adhesives with improved properties such as strength, thermal resistance, and abrasion resistance. Such adhesives can be applied directly to the materials requiring adhesion or even coated onto a substrate such as a sheet or fiber strand. Materials requiring adhesion could include, but are not limited to; wood, paper, cellulose fibers, inorganic particles, plastics, elastomers, glass fibers, carbon fibers and cloth. A sheet might be but is not limited to; paper, plastic film, woven fabric, non-woven fabric, wood, composition board, glass, ceramic, metal. The sheet can be flat or three-dimensional (e.g., contoured). Fibers that could be coated with this adhesive include but are not limited to; natural fibers such as cotton and wool; synthetic fibers such as nylon, rayon, and polyester; and inorganic fibers such as glass, carbon, and boron nitride.

Nan composites, and Nan composite adhesives, are not exempt from traditional challenges of other well-known composites because the advancement of Nan composites requires both matrix/filler compatibility and the effective dispersion of filler within the adhesive formulation. If either of these requirements is not achieved, the properties of the Nan composite adhesive coating will suffer, and may become less effective than the corresponding unfilled coating composition. Therefore, much of the work surrounding Nan composites is directed to attaining homogenous mixtures and finding ways to assure the filler is functionalized to interact with the matrix.

A significant portion of the Nan composite materials on the market today are based upon manacle fillers. In general manacle fillers consist of platy or laminar clays, some of which are naturally occurring clays (e.g., kaolin and smectite), or synthetic clays (e.g., fluorohectorite and fluoromica). Each of the nanoclays is a layered silicate, held together by an intercalation layer—often containing water. In some of the disclosed embodiments, the nanocomposite filler consists of “exfoliated” two-dimensional sheets of clay. In such embodiments, the individual layers are separated from one another and dispersed throughout a polymer matrix. The exfoliation, or separation, process is quite complex and often incomplete, thus frequently leaving larger pieces of clay that create weak points in the polymer matrix. Exfoliation generally involves first swelling the clay by introducing small interacting molecules or polymers into the intercalation space existing between the clay layers, to increase the distance between layers, and finally introducing a shear force or energy to complete the separation of the layers.

As many silicates are naturally hydrophilic and many industrially important polymers are hydrophobic, the clay may also be modified or functionalized before mixing the two together, while seeking to disperse the filler in the polymer matrix. Otherwise the filler and matrix will separate rather than form a homogeneous composite. Moreover, the organic surface modifiers used to increase the binding between filler and matrix often adversely affect the properties of the composite.

Traditional adhesive polymer composite adhesives and coatings have several potential limitations. First, the addition of filler materials to the adhesive coating typically strengthens the adhesive, but reduces the tack, which is needed to obtain the required adhesion. Tackiness theory predicts that as the elastic modulus of the coating increases, the tack energy decreases (C. Gay, L. Leibler, Physical Review Letters, 82 (5), 936-9.) In a typical platy clay nanocomposite, such as montmorillonite and polypropylene for example, dynamic mechanical measurements indicate that storage modulus (G′) increases as filler is added, whereas the tangent of the ratio of the loss modulus (G″) to G′, which correlates with tackiness, decreases. (V. G. Gregoriou, G. Kandilioti, S. T. Bollas, Polymer 46 (2005), 11340-50.) Adhesive formulation utilizing platy clays requires exfoliation of the clay, which adds complexity and cost. Specific chemical interactions are needed to obtain exfoliation, which may lead to increased material and processing costs. In addition, the need for specific chemistry limits the number of available polymers that will be compatible with the coatings.

Exfoliation can be quite challenging and expensive, due to the addition of the extra processing step(s). As noted above, even the best processes do not fully exfoliate non-synthetic clay due to intercalated multivalent ions that bind adjacent sheets, crystal defects binding adjacent sheets and other causes. Thus, total de-lamination is rare in natural clays. When non-exfoliated clay particles become incorporated into a nanocomposite, the characteristic weak binding between sheets in the non-delaminated particles can result in weak points throughout the polymer composite matrix. The exfoliation challenge leads to difficulty in obtaining a good dispersion and homogeneous distribution, thereby producing a polymer composite with particles that are agglomerates of non-separated sheets. A good dispersion means the platy clay, or more specifically the halloysite nanotubes (may be referred to as “HNT” below) are evenly distributed and not significantly clumped or aggregated at the various length scales in the composite (i.e., from the nano-scale to macroscopic-scale). A good dispersion of non-delaminated clay in a polymer is not as desirable as a good dispersion of delaminated platy clay. For HNTs a good dispersion means obtaining very few aggregates of individual HNTs in a polymer matrix.

In contrast, carbon nanotubes (CNTs) show different behavior, exhibiting an increase in both strength and tack, achieving maximum results at a critical concentration (Advanced Materials 2006, 18, 2730-2734). However, CNT adhesives have many disadvantages. CNTs are difficult to disperse in many solvents, and so require chemical functionalization for specific solvents. In addition, the interaction between the filler and the matrix is critical to the properties of any adhesive composite coating. Uniform and complete dispersion of the nanoparticle is often difficult to obtain, due to specific chemical interactions required for dispersing the filler in the polymer/solvent solution or latex dispersion. An additional disadvantage of CNT adhesives is their unavoidable black coloration, which may limit the applications where such adhesives may be employed. CNTs are very expensive, so would not be cost effective for conventional adhesive applications, and would likely be of interest primarily for specialty applications in which a special property, such as conductivity, is needed.

The present disclosure addresses the weaknesses in current adhesive composites while providing additional functionality, or multifunctionality, to these composites that is not currently available with two-dimensional nanoclay or carbon nanotube adhesive composites. Disclosed embodiments include those directed to polymeric composites including nanoclays, and more particularly those utilizing nanotubes (e.g., mineral and synthetic nanotubes), and methods for preparing such composite adhesives. The advantages include ease of dispersion, low material and processing costs, and increased adhesive strength without compromising the tackiness required for an adhesive. Furthermore, the use of nanotubes in the composites provides additional functionality via the inner open space or cavity of the tube, particularly the ability to load, store, capture, release, and/or exchange chemical, physical or biological agents—thereby incorporating active chemical agents, and possibly physically or biologically active agents, within the tubes, or as coating on the tube surfaces.

Disclosed in embodiments herein is an adhesive comprising: a polymer matrix; and a filler consisting essentially of mineral nanotubes, wherein said polymer matrix and said nanoparticle filler, in combination, form a polymeric nanoparticle adhesive.

Also disclosed in embodiments herein is a method for making a polymer nanocomposite adhesive coating, including: producing a milled halloysite material having a nanotubular particle structure; and combining an adhesive polymer material with said surface treated halloysite material to form the polymer nanocomposite adhesive.

### BRIEF DESCRIPTION OF THE DRAWINGS

FIG. 1 is a photomicrograph of an exemplary adhesive composite coating employing halloysite clay nanotubes in latex adhesive in accordance with an aspect of the disclosed embodiments;

FIG. 2 is an illustrative representation of the apparatus employed to measure the tackiness of various adhesive materials produced in accordance with the disclosed embodiments;

FIGS. 3A-B includes orthographic views of the apparatus employed to measure the cohesion of various materials produced in accordance with the disclosed embodiments;

FIGS. 4-8A are graphical representations of testing results as described relative to the embodiments and examples set forth herein;

FIG. 8B is an illustrative example of an adhesive film after completion of the pin on disk test.

The various embodiments described herein are not intended to limit the invention to those embodiments described. On the contrary, the intent is to cover all alternatives, modifications, and equivalents as may be included within the spirit and scope of the invention as defined by the appended claims.

### DETAILED DESCRIPTION

A platy clay shall mean a layered or sheet-like inorganic clay material, such as a smectite or kaolin clay, this in the form of a plurality of adjacent bound layers or sheets in a single clay particle, where each layer or sheet has both faces and edges, and where the vast majority of the individual clay layers or sheets decorate the outer surface of the clay particle.

As used herein the term “halloysite” is a naturally occurring clay exhibiting, theoretically, the chemical formula Al₂Si₂O₅(OH)₄.nH₂O (in actuality halloysite may have substitution into the octahedral and tetrahedral sites, such that the formula changes slightly); material that is believed to be the result of hydrothermal alteration or surface weathering of aluminosilicate minerals, such as feldspars. Halloysite, in its hydrated form, may also be referred to as endellite. Halloysite further includes tubular nanoparticles therein (halloysite nanotubes (HNT)). In alternative embodiments, halloysite may further include synthetic halloysite, for example as disclosed in U.S. Pat. No. 4,150,099, hereby incorporated by reference in its entirety, and other non-naturally occurring tubular nanoparticles.

A “nanoparticle composite adhesive” or “nanocomposite adhesive” for short, is intended to include a polymeric composite adhesive material wherein at least one component comprises an inorganic phase, such as clay (e.g., platy clays, a halloysite material, etc.), with at least one dimension of the inorganic component is in the range of about 0.1 to 500 nanometers.

As more particularly set forth below, the disclosed materials and methods are directed to polymeric composite adhesives (e.g., latex-based adhesives), and nanoclay nanocomposite adhesives, particularly those utilizing mineral nanotubes (e.g., tubules having at least one dimension in a nano scale along with a large length-to-diameter ratio), and a method for preparing such composites. The advantages include ease of dispersion, low material and processing costs, and increased strength (e.g., coating strength) without compromising tack. The use of a nanotubular filler eliminates the need for exfoliation as required by other two-dimensional nanoclay fillers, and thereby avoiding the possible detrimental delamination during use of composites incorporating clays that are not fully delaminated. In other words, the nanotubes are essentially discrete nanoparticles and, therefore, need no additional chemical exfoliation to provide the desired dispersion.

Another advantage arises from the additional functionality that is possible with a tubular geometry as opposed to a laminar structure. This functionality is enabled by the inner open space or cavity of the tube, sometimes referred to as a lumen, and particularly the ability to fill the tubes with active agents, or to coat the tube surfaces, such as with metal or metal oxides. Advantages may also arise simply by virtue of the selective chemistry that occurs in certain tubes, where the inner surfaces have different reactivities, or chemical and physical properties, than the outer surfaces.

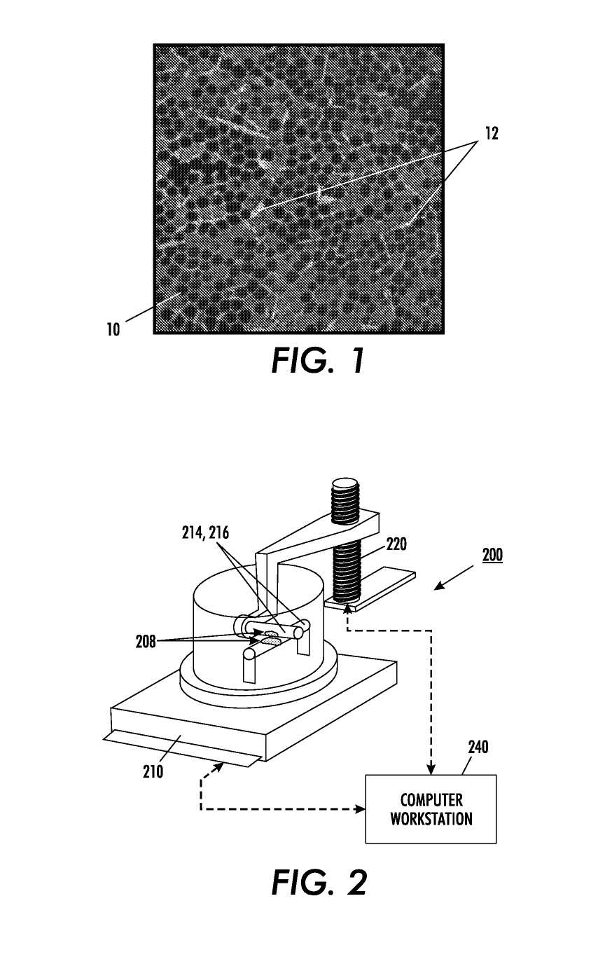

In accordance with an embodiment disclosed herein, one such mineral nanotube that is naturally occurring is the halloysite nanotube. Referring, for example, to FIG. 1, there is depicted an atomic force microscope image of a polymeric nanoparticle composite, comprising a latex polymer matrix 10 and a filler including halloysite nanoparticles 12, which resides at the boundaries of the latex particles. The halloysite nanotubes 12 lie at the boundaries of the latex, and also bridge neighboring latex particles. It is further believed that halloysite nanotubes that span many latex particles provide improved mechanical properties to the nanocomposite—that is the high aspect ratio tubes result in improved mechanical performance of the nanocomposite. As described below, the halloysite nanoparticles have a generally tubular or scroll-like shape that is believed to be formed during weathering of a precursor mineral, typically a feldspar. The aluminosilicate weathers to form sheets comprising a bilayer structure with distinct, but covalently linked octahedral and tetrahedral layers, rich in aluminum and silicon, respectively. The hydrated form of the clay consists of bilayer stacks, with apposed bilayers hydrogen bonded via an intercalated water layer. One of the consequences of this bilayer structure is that the octahedral and tetrahedral layers can differ, in effective areal charge per metal atom—this difference causes otherwise planar sheets of halloysite to curl and eventually co-assemble into a scroll-like morphology.

The combination of silica and alumina further leads to potentially useful characteristics of halloysite and other clays (e.g., imogolite) when in the scroll-like or tubular morphology, characteristics not believed to be seen in either two-dimensional nanoclays or other nanotubes. The fact that the tubes are rolled in one direction means that the inside of the tube has a different surface chemistry when compared to the outside. Such a differential may be useful to perform selective chemistry or to confine or organize chemical agents within the tube, as opposed to on the exterior of the tube, or vice versa. The edges of the HNTs are indeed like the edges of regular clays, so that there will be a pH dependent edge charge that can be useful, and uniquely so if combined with the hollow nature or the inside/outside surface chemistry differential. For example, at a pH of less than the isoelectric point of the edges (about pH 6), the alumina terminated ends of the tube become positively charged, while the rolled sheet-like aluminosilicate surfaces remain negatively charged to their isoelectric point (a pH of about 2 for silica); in other words the aluminosilicate walls act as a polyvalent anion, while the ends of the tubes are amphoteric. Differential surface charges below a pH of about 6 can result in a self-organizing network of tubes generally arranged end to wall, at least on a localized level. Differential surface charges also open up an opportunity to do selective chemistry to confine or organize chemical agents within one area of the tube.

Halloysite nanotubes typically range in length from about 100 nm to 10,000 nm (10 microns), with an average (dependent on the natural source) of about 1,200 nm. In one embodiment, the nanocomposite material includes halloysite nanoparticles having a cylindrical length of about 100 nm to about 6,000 nm, with an average of approximately 1,200 nm. Inner diameters of halloysite nanotubes range from about 10 nm up to about 200 nm with an average of approximately 40 nm, while outer diameters range from about 20 nm to about 500 nm with an average of approximately 100 nm. In one embodiment, the nanocomposite material includes halloysite nanoparticles having an average outer cylindrical diameter of less than about 500 nm. It is also possible to characterize the halloysite nanotubes using a relationship between certain dimensions, i.e., an aspect ratio, e.g., length divided by diameter. In one embodiment it is believed that halloysite nanotubes may exhibit a length/diameter ratio of between about 0.2 and 250, with an average aspect ratio of about 12.

Native halloysite is a hydrated clay with an intercalated water layer giving a basal spacing of about 10 Å. Subsequent drying of the clay can lead to the dehydrated form of the clay where the intercalated water has been driven off and the basal spacing reduced to 7 Å. Hydrated and dehydrated halloysite can be distinguished through X-ray diffraction. Dehydration is a naturally irreversible process, though researchers have had some success with artificially rehydrating the tubes with a potassium acetate treatment. In the hydrated form the intercalated water can be substituted out for small cations including organics such as glycerol.

Halloysite is a useful constituent of nanocomposite adhesive coatings for the purpose of mechanical, physical and thermal property improvement. Nanocomposites including halloysite nanotubes may also be used in embodiments where the filler is surface modified, including where the filler is coated for functionality (e.g., metal coating). In such an embodiment, the coated HNT filler may be used for conductive coatings and shielding, for example.

Alternatively, as described herein the tubular filler may itself also be filled with an agent for elution or eluate (e.g. minerals, light emitting substances such as fluorescent or phosphorescent substances, colorants, antioxidants, emulsifiers, biocides, antifungal agents, pesticides, fragrances, dyes, optical brighteners, fire retardants, self-healing polymers, or mixtures and combinations thereof etc.), as described, for example, in U.S. Pat. No. 5,651,976 by Price et al., which is hereby incorporated by reference in its entirety.

Also contemplated is an embodiment where the composite filler, for example, HNT, is in turn filled with one or more materials such as colorants, antioxidants, emulsifiers, biocides, antifungal agents, pesticides, fragrances, dyes, optical brighteners, fire retardants, self-healing polymers and plasticizers, or where multiple fillers act in parallel to provide a plurality of properties or advantages including mechanical properties, whiteness, temperature resistance, etc. Although set forth in the disclosed embodiments as ranges of HNT for particular mechanical properties, the present disclosure further contemplates the use of alternative ranges of HNT being added in order to provide the advantageous affects of one or more eluates or other materials described above.

It shall be further contemplated that adsorption or absorption of agents into the tubes of the filled latex may produce adhesives and similar materials suitable for various applications. For example, the filler itself may also be filled with an adsorbent or absorbent substance, for example for removing volatile organics from air, or for fluid uptake. Furthermore, the interior of the filler may be surface modified for making the above mentioned elution, or sorption processes more efficient. Further, these tubular fillers may themselves be filled with catalytically active substances or moieties such as enzymes or various non-biologically derived catalysts. In another alternative embodiment contemplated, agents such as surfactants and coating aides may be adsorbed or absorbed by the tubes, thus preventing them from migrating to the surface and compromising adhesion or tack. The migration of surfactants through latex films to a surface, and a resulting compromise in tack, is well-known to those skilled in the art.

Although described herein with respect to a particular nanotubular mineral filler, such as halloysite, it will be appreciated that various alternative materials, both naturally occurring and synthetic, may also be employed. Other inorganic materials that will, under certain conditions, form tubes and other microstructures include other 1:1 sheet silicate clays, such as imogolite, where an effective mismatch in the surface area per charge in apposed tetrahedral and octahedral layers exists. Also included are sulfosalts such as cylindrite and boulangerite. Other materials could include layered double hydroxide materials with an effective mismatch in the area per charge of their respective, apposed octahedral and tetrahedral layers.

The surface of halloysite, particularly the exterior surface of halloysite or other tubular clay materials, may be modified to impart compatibility with the polymer matrix, as described in U.S. Pat. No. 6,475,696, which is hereby incorporated by reference in its entirety. In this instance, “compatibility” may be defined as an increased tendency for individual tubes to be well dispersed within the polymer matrix, and or an increased tendency for individual tubes to be more adhesively bound with polymers or other components/additives within the matrix. For example, the polymer matrix may contain compatibilizers (e.g., chemicals that strongly interact with halloysite). Alternatively, other components besides the polymer and HNTs could impart compatibilization between the HNTs and polymers.

Dispersion of individual tubes within the polymer matrix is desirable for obtaining uniform properties throughout the polymer-halloysite nanocomposite. Compatibilizers that increase the degree of dispersion of nanotubes within the polymer matrix will therefore increase the homogeneity of physical and or chemical properties within the composite. This is also desirable in many instances as it lowers the cost per unit performance of the nanocomposite. In many cases a compatibilizer that increases the dispersion of tubes in the polymer matrix will also increase the adhesion of the individual tube to components in the polymer matrix.

Adhesion between individual halloysite nanotubes and a polymer matrix (including any other components/additives in the matrix) arises through two distinct mechanisms (or their combination): i) due to net attractive forces acting between the HNT surfaces and the polymer matrix, and ii) formation of mechanical interlocking (as in Velcro®). In the first case, the adhesion observed can be from either net attractive physical and/or chemical forces between the surfaces.

Adhesion due to attractive forces between individual halloysite nanotubes and the polymer matrix is governed by the total integrated attractive force between the tube surface and the polymer matrix over the area of contact. Therefore, strong bonds and high contact area is one way to achieve a desirably strong adhesion. If the bonds between individual tubes and polymer chains or other components in the matrix are weak, but the contact area (and bond density) high, then suitably high adhesion might also be achieved. Alternatively, strong bonds might be sufficient over a smaller contact area. Examples of bonding include: weak bonds such as those acting through London dispersion forces; stronger bonds acting via Keesom forces between permanent dipoles; and stronger bonds still are hydrogen bonds. Stronger again are ionic bonds, and even stronger bonds again are covalent bonds.

It is, therefore, desirable in some circumstances to add agents that mediate the compatibilization of the tubes in the polymer matrix via the mechanisms mentioned above. The nature of the specific compatibilization agents will vary widely depending on the particular polymer and the particular filler material employed. These compatibilization agents can include inorganic and organic molecules, compounds or other entities, including those from biological sources. These can be neutral or ionic. Useful neutral organic molecules may include polar molecules such as amides, esters, lactams, nitriles, ureas, carbamates, diimides, carbodiimides and thiocarbamides. Useful inorganic charged compounds may include carbonates, phosphates, phosphonates, sulfates, sulfonates, nitrate compounds, and the like. Preferred neutral organics can be monomeric, oligomeric, or polymeric. Other useful ionic compounds may include cationic surfactants including -onium species such as ammonium (primary, secondary, tertiary, and quaternary), phosphonium, or sulfonium derivatives of aliphatic, aromatic or arylaliphatic amines, phosphines, and sulfides, which can electrostatically bind to the surfaces of the halloysite nanotube material.

Another class of useful compatibilization agents may include those that are covalently bonded to the surfaces of the inorganic nanotubes such as halloysite.

Illustrative of such groups that may be useful in the practice of the disclosed embodiments are organosilane, organozirconate, and organotitanate coupling agents. Organosilanes can function as compatibilizing agents that are highly specific to a selected polymer system. In some embodiments, the compatibilizing agent will include a moiety which bonds to the surface of the material and will not be reactive with the polymer. The agent may also include a moiety, which may not bond with the nanotube material, but is compatible with the polymer. Clay particles treated with organosilanes, particularly di-alkoxy and tri-alkoxy silanes, (R1O)₂R2R3Si where R1 is alkyl, benzyl or aryl; R2 is independently either alkyl, benzyl, aryl or R1O; and R3 is alkyl, vinyl, glycidoxyalkyl, alkoxy, alkoxyalkyl, aminoalkyl, thioalkyl, chloroalkyl, methacryloxyalkyl, or acryloxyalkyl; can be particularly useful for producing compatible mixtures of clay with polymers. Representative members of this class include but are not limited to: trimethoxyethylsilane, triethoxyoctylsilane, dimethoxydimethylsilane, dimethoxymethylvinylsilane, triethoxyglycidoxypropylsilane, triethoxymethacryloxypropylsilane, trimethoxyaminopropylsilane, trimethoxymethoxypropylsilane. Disiloxanes of the same type of structure are also useful, R3(R1O)₂Si—X—Si(R1O)₂R3 where R1 and R3 are as described above and —X— is a linking group such as alkylene. A representative but not limiting example is 1,2bis(triethoxysilyl)ethane. Other organosilane compatibilizers include compounds where trichlorosilyl functionality is used in place the trialkoxysilyl group of the above general formula; Cl₃SiR3, where R3 is defined as above. A representative, non-limiting example is trichlorosilylbutane.

Examples of various types of compatibilizing agents that may be useful for treating clays and other inorganic materials having nanotubular structures are found in the disclosures of U.S. Pat. Nos. 4,894,411; 5,514,734; 5,747,560; 5,780,376; 6,036,765; and 5,952,093, all of which are hereby incorporated by reference in their entirety for their teachings.

Treatment of a halloysite nanotube clay by the appropriate compatibilizing agents is accomplished by any known method, such as those discussed in U.S. Pat. Nos. 4,889,885; 5,385,776; 5,747,560; and 6,034,163, which are also hereby incorporated by reference in their entirety. The amount of compatibilizing agent can vary substantially provided that the amount is effective to compatibilize the nanotubes to obtain a desired, and substantially uniform, dispersion. It is contemplated that typically the amount can vary from about 10 millimole/100 g of material to about 1000 millimole/100 g of material.

Similarly, polymeric materials may effectively compatibilize polymer-HNT systems. Specifically, copolymers are often used, in which one type of monomer unit interacts with the HNTs, while the other monomer units interacts with the polymer. For example, polypropylene-maleic anhydride copolymer may be added to a polypropylene-HNT nanocomposite to provide compatibilization of the system. The polypropylene segments are miscible with the polypropylene homopolymer, while the anhydride segments interact with HNT surface, thus improving the homogeneity of the resulting nanocomposite.

Furthermore, nanoparticles, inorganic clusters and other materials adhered to the surfaces of individual nanotubes can produce an increased roughness on the surface of the nanotubes that may effectively enhance the compatibility of nanotubes with the polymer matrix.

As noted above, the halloysite or other inorganic nanotubes may be employed as fillers in nanocomposite adhesive materials using any polymer or copolymer as the matrix, including thermoplastics, thermosets, elastomers, and the like. Examples include polymers such as polyvinyl chloride, polyvinylidene chloride, polyurethanes, acrylic-based polymers, methacrylic-based polymers, polyesters, polystyrene, fluoropolymers, and similar materials generally characterized as thermoplastics. Thermoplastic elastomers vary widely and can include, but are not limited to, polyurethane elastomers, fluoroelastomers, natural rubber, poly(butadiene), ethylene-propylene polymers, and the like. Various polymers may also be utilized, including, but not limited to matrix thermoplastic resins including polylactones such as poly(pivalolactone), poly(caprolactone), and the like, polyurethanes derived from reaction of diisocyanates such as 1,5-naphthalene diisocyanate, p-phenylene diisocyanate, m-phenylene diisocyanate, 2,4-toluene diisocyanate, 4,4′-diphenylmethane diisocyanate, 3,3′-dimethyl-4,4′diphenyl-methane diisocyanate, 3,3-′dimethyl-4,4′-biphenyl diisocyanate, 4,4′-diphenylisopropylidene diisocyanate, 3,3′-dimethyl-4,4′-diphenyl diisocyanate, 3,3′-dimethyl-4,4′-diphenylmethane diisocyanate, 3,3′-dimethoxy-4,4′-biphenyl diisocyanate, dianisidine diisocyanate, tolidine diisocyanate, hexamethylene diisocyanate, 4,4′-diisocyanatodiphenylmethane and the like; and linear long-chain diols such as poly(tetramethylene adipate), poly(ethylene adipate), poly(1,4-butylene adipate), poly(ethylene succinate), poly(2,3-butylenesuccinate), polyether diols and the like; polycarbonates such as poly(methane bis(4-phenyl) carbonate), poly(1,1-ether bis(4-phenyl)carbonate), poly(diphenylmethane bis(4-phenyl)carbonate), poly(1,1-cyclohexane bis(4-phenyl)carbonate), poly(2,2-bis-(4-hydroxyphenyl)propane) carbonate, and the like; polysulfones, polyether ether ketones; polyamides such as poly(4-amino butyric acid), poly(hexamethylene adipamide), poly(6-aminohexanoic acid), poly(m-xylylene adipamide), poly(p-xylyene sebacamide), poly(2,2,2-trimethyl hexamethylene terephthalamide), poly(metaphenylene isophthalamide) (Nomex), poly(p-phenylene terephthalamide)(Kevlar), and the like; polyesters such as poly(ethylene azelate), poly(ethylene-1,5-naphthalate), poly(ethylene-2,6-naphthalate), poly(1,4-cyclohexane dimethylene terephthalate), poly(ethylene oxybenzoate) (A-Tell), poly(para-hydroxy benzoate) (Ekonol), poly(lactic acid), poly(1,4-cyclohexylidene dimethylene terephthalate) (Kodel) (cis), poly(1,4-cyclohexylidene dimethylene terephthalate) (Kodel) (trans), polyethylene terephthlate, polybutylene terephthalate and the like; poly(arylene oxides) such as poly(2,6-dimethyl-1,4-phenylene oxide), poly(2,6-diphenyl-1,4-phenylene oxide) and the like poly(arylene sulfides) such as poly(phenylene sulfide) and the like; polyetherimides; vinyl polymers and their copolymers such as polyvinyl acetate, polyvinyl alcohol, polyvinyl chloride, polyvinyl butyral, polyvinylidene chloride, ethylene-vinyl acetate copolymers, and the like; polyacrylics, polyacrylate and their copolymers such as poly(ethylacrylate), poly(n-butylacrylate), polymethylmethacrylate, polyethylmethacrylate, poly(n-butylmethacrylate), poly(n-propylmethacrylate), polyacrylamide, polyacrylonitrile, polyacrylic acid, ethylene-acrylic acid copolymers, ethylene-vinyl alcohol copolymers acrylonitrile copolymers, methyl methacrylate-styrene copolymers, ethylene-ethyl acrylate copolymers, methacrylated budadiene-styrene copolymers and the like; polyolefins such as (linear) low and high density poly(ethylene), poly(propylene), chlorinated low density poly(ethylene), poly(4-methyl-1-pentene), poly(ethylene), poly(styrene), and the like; ionomers; poly(epichlorohydrins); poly(urethane) such as the polymerization product of diols such as glycerin, trimethylol-propane, 1,2,6-hexanetriol, sorbitol, pentaerythritol, polyether polyols, polyester polyols and the like with a polyisocyanate such as 2,4-tolylene diisocyanate, 2,6-tolylene diisocyante, 4,4′-diphenylmethane diisocyanate, 1,6-hexamethylene diisocyanate, 4,4′-dicycohexylmethane diisocyanate and the like; and polysulfones such as the reaction product of the sodium salt of 2,2-bis(4-hydroxyphenyl)propane and 4,4′-dichlorodiphenyl sulfone; furan resins such as poly(furan); cellulose ester plastics such as cellulose acetate, cellulose acetate butyrate, cellulose propionate and the like; silicones such as poly(dimethyl siloxane), poly(dimethyl siloxane), poly(dimethyl siloxane co-phenylmethyl siloxane), and the like, protein plastics, polyethers; polyimides; polyvinylidene halides; polycarbonates; polyphenylenesulfides; polytetrafluoroethylene; polyacetals; polysulfonates; polylactic acid, polhydroxyalkanoates, polyester ionomers; and polyolefin ionomers. Copolymers and/or mixtures of the aforementioned polymers can also be used.

Thermosetting polymers may also be utilized, including, but not limited to various general types including epoxies, polyesters, epoxy-polyester hybrids, phenolics (e.g., Bakelite and other phenol-formaldehyde resins), melamines, silicones, acrylic polymers and urethanes. Preferably, thermosetting polymers could be formed in-situ, through introduction of monomers, followed by curing utilizing heat, ultraviolet radiation, or the like. Also, starch, starch-based polymers and other biopolymers are thermosetting polymers that may be utilized along with epoxidized natural vegetable oils, bioresins, protein based thermosets such as prolamins (e.g., zein or kafirin). For an example of a prolamin thermosets, reference is made to United States Patent Publication 2006/0155012.

Biodegradable polymers may also be utilized for forming biodegradable or partially biodegradable nanocomposite coatings with nanotubes. Included in the range of polymers that may be used are biopolymers such as polysaccharides (e.g. starch), starch derivatives, cellulose, cellulose derivatives, polylactic acid polymers, polyhydroxyalkanoate polymers, polypeptides and proteins such as caseins, gelatin, collagens, mucins, wheat gluten, silk fibroin etc.

Gels may also be utilized in forming lubricious, porous or dimensionally responsive nanocomposite coats with nanotubes. Included in the range of gels are lipid or organogels (e.g., greases, lubricant gels), sol-gels, xerogels, aerogels, hydrogels, protein hydrogels, polyelectrolye gels, environmentally sensitive gels (e.g., thermosensitive, pH sensitive, electroresponsive, etc.).

Polyacrylic nanocomposite adhesives have been formed, as will be discussed in detail below relative to some of the examples.

It will be further appreciated that various manufacturing methodologies or techniques can be employed in the formation of materials or goods incorporating the nanocomposite materials described herein. These manufacturing process include, but are not limited to, coating, expandable-bead, foaming (see e.g., U.S. Pat. No. 5,855,818, hereby incorporated by reference), thermoforming, vacuum forming, hand lay-up, filament winding, casting, and forging.

The practice of one or more aspects of the disclosed embodiments are illustrated in more detail in the following non-limiting examples, including those in which Halloysite was dispersed into a latex emulsion to produce nanocomposite adhesives. It will be appreciated that various levels and related ranges of Halloysite nanotube fillers may be employed, both approximating and between the various filler levels described herein, with results comparable to those described below. These are latex polymers typically used for pressure sensitive adhesive (PSA) applications.

### EXAMPLE 1

Halloysite nanotube material, particularly Halloysite premium EG, was obtained from Nanoclays and Technologies, Inc. The halloysite nanotube material was dispersed into a commercially available low-T_{g} Dow Corning acrylic copolymer latex emulsion (MG-0580) at 5, 10, 15 and 20% HNT loading (weight percent solids). MG-0580 is one of a number of acrylic adhesives, or more specifically aqueous pressure sensitive adhesives available from Dow Corning.

Preparation of the HNT dispersion

A DISPERMAT VMA-Getzmann GMBH-D-5226 Reichshof, with a 25 mm disk knife, was used to prepare the halloysite dispersion. The HNT powder was added in small portions to water under stirring at 4000 rpm. When all the powder was added, the blend was left under stirring at 4000 rpm for an additional 10 minutes. The suspension was then placed into a conical flask with connection to vacuum to evacuate the HNTs. Dry content of the suspension was determined by evaporation.

Preparing of Suspensions containing Latex with Low T_{g} and HNT

Latex MG-0580 (T_{g}-45° C. approx.) was chosen for these experiments. Three suspensions of this type were prepared with 5, 10 and 20% weight percent solids HNTs (5% HNT, 10% HNT and 20% HNT) using the suspension described above. More specifically, the halloysite suspension was mixed with a latex dispersion under mild magnetic stirring.

A Petri dish bottom was covered with silicon treated plastic film. The pure latex and the latex-HNT blends were poured into three Petri dishes with a pipette. The amount of the blend to transfer into a dish was calculated to create an approximately 1.0 mm thick film after drying. The blends were left in the ambient environment for two days and were then put in an oven at 50° C. overnight to further cure the films. After drying, the films were covered by another piece of the silicon treated plastic film to make handling easier.

### COMPARATIVE EXAMPLE 1A

Comparative Example 1A was prepared in a manner consistent with Example 1 above, but without the HNTs added (No Additives).

### COMPARATIVE EXAMPLE 1B

A 40% dispersion of Montmorillonite K10 platy clay in water was mixed using the DISPERSMAT mixer, as in Example 1. MG-0580 latex dispersion was added to the clay dispersion in proportions sufficient for obtaining final dry weights of 1%, 5% and 10% clay in the final latex film. Thick latex films were cast from 1% and 5% formulations (1% Clay, 5% Clay), dried, and tested as in Example 1. The 10% formulation was badly flocculated, so a film was not made of that sample.

Rheology Measurements

To measure viscoelastic properties G′ (storage modulus) and G″ (loss modulus), a Rheometer CS10 Bohlin was used. The measurements were done in oscillation mode with the following parameters: stress 1000 Pa and frequency from 0.001 to 10 Hz. The measurement system was Plate-Plate (serrated), 25 mm in diameter and 1 mm gap. Every film sample was cut with scissors as a circle (the same size as upper plate), placed on the bottom plate, and pressed to bridge the approximately 1.0 mm gap.

Tackiness Method

The device 200 was used to measure the tackiness between “adhesive” 208 placed on two glass rods is shown in FIG. 2. The readings were recorded on the balance or similar load cell 210, which is connected to a computer 240. Before applying the adhesive, the glass rods 214, 216 (actually small glass tubes) were washed with tap water and then with Milli-Q water. They were then washed with ethanol and dried in a heated oven at 100° C. Polyethylene (Parafilm “M”) and glass rods were used in the experiments and they were prepared in the same manner as the glass. The raw data was obtained by first bringing the surfaces in contact, (glass rods 214, 216 oriented generally perpendicular to one another) using a motorized jack-screw 220 under the control of the computer 240, for example at a linear speed of 0.2 mm/s. When surfaces are in contact there is a positive load exerted on the balance that may be displayed and/or sensed by the computer. The direction is then switched or reversed and the surfaces are pulled apart. The resulting tack force that arises from the adhesion of the rods 214, 216 is then recorded by the computer as a negative reading from the balance (e.g., maximum negative force before separation).

The measurements are repeated on the same sample with increasing positive load—load applied before reversal of the jack-screw 220—and the data are then evaluated by taking the ratio between the tack force and the applied load. In order to reduce the data and to have a standardized comparison, the ratio is extrapolated to a zero applied load by linear regression.

Pin on Disc Measurement

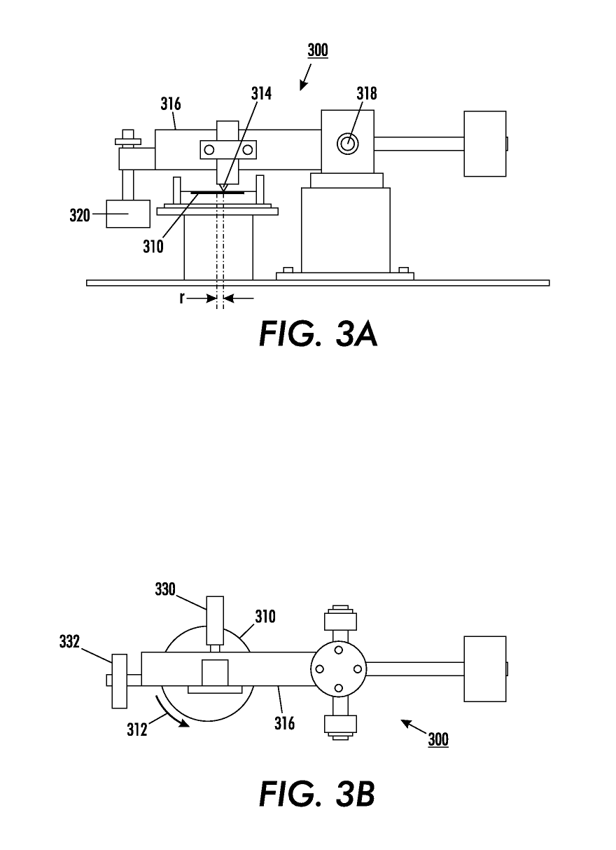

The pin on disc equipment 300, shown in both side and top orthogonal views in FIGS. 3A-B, respectively, was adapted for evaluation of internal cohesion of latex films. The equipment 300 is designed for rotating a disc 310, rotating in the direction of arrow 312 and relative to a fixed, weighted pin or pointed member 314 at a chosen radius (r) from the center of the disc, similar to the manner of the arm of a conventional phonograph with a needle riding on a record. Arm 316 was held in position but allowed to pivot at location 318 so as to permit vertical displacement of the arm's end. In the present experiments the applied vertical load was controlled by a weight or loaded spring 320, and was held constant during the measurement. The tangential force, F, was recorded continuously using one or more transducers 330 and 332. The pin glides on the disc at a radius, r, of approximately 9 mm. The sliding speed, or speed of the disc, as controlled by a drive motor (not shown) was set to 60 rpm. The time for each measurement was 2 minutes and the applied vertical load was 11 N.

Results

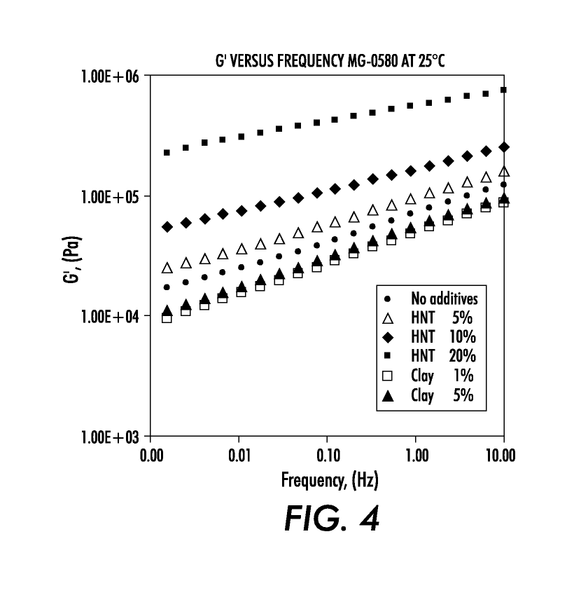

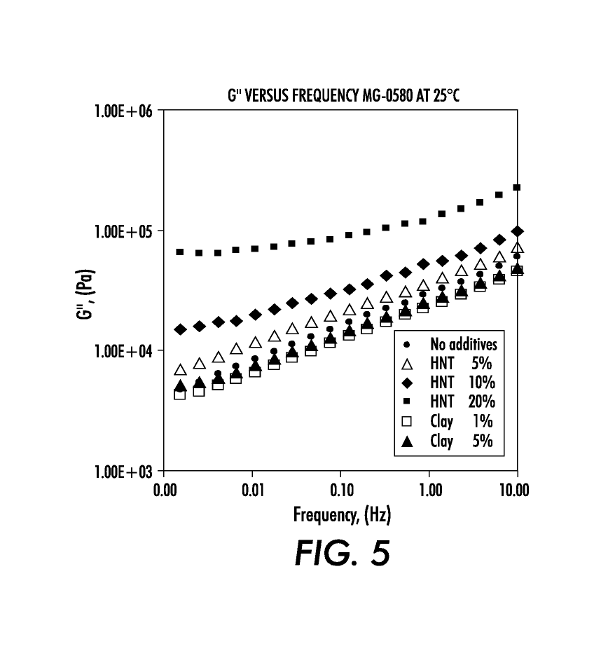

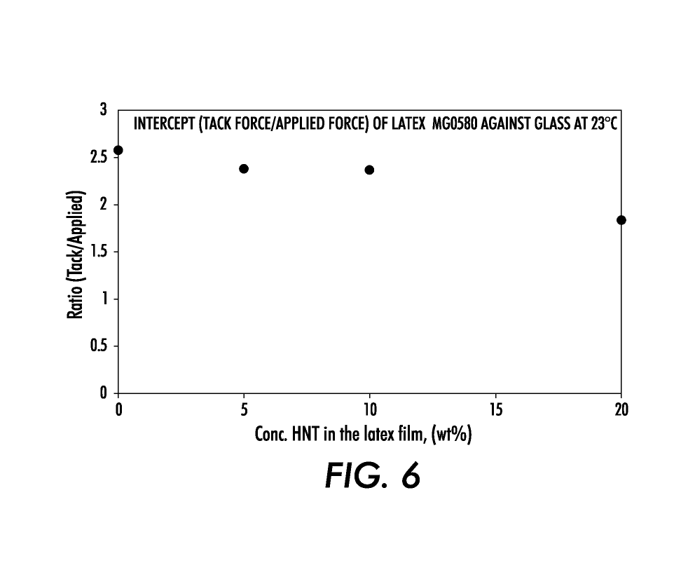

Storage and loss modulus measured using rheometry are presented in FIGS. 4 and 5, and tack and cohesive strength results are presented in FIGS. 6, 7, and 8. More specifically, FIG. 4 illustrates the measured storage modulus (G′) versus frequency for an MG-0580 latex comparative example, with no HNT's, 1 wt-% and 5 wt-% platy clay added, and with and 5, 10, and 20 wt-% HNT added. FIG. 5 depicts the loss modulus (G″) for an MG-0580 latex comparative example, again versus frequency, using the same material compositions as in FIG. 4.

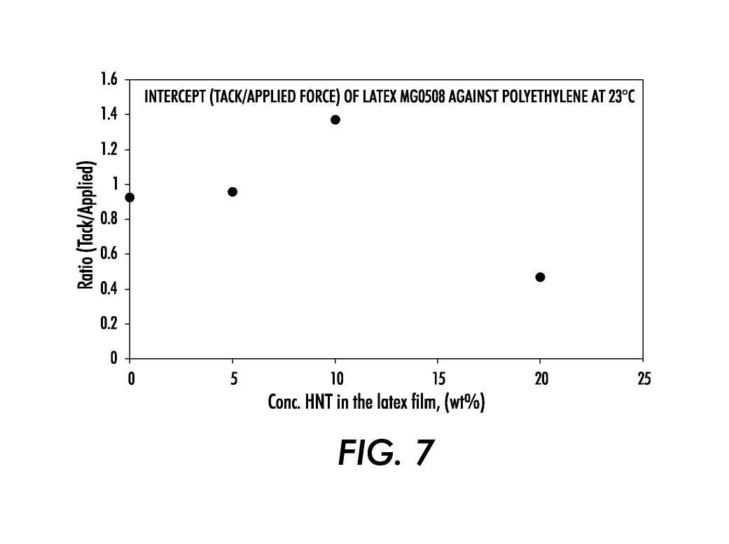

The results of the tack measurement experiments are depicted in FIGS. 6-7. In FIG. 6, tack measurements are illustrated for 0, 5, 10, and 20 wt-% HNTs in MG-0580 against glass. FIG. 7 illustrates tack measurements for 0, 5, 10, and 20 wt-% HNTs in MG-0580 against Polyethylene (PE).

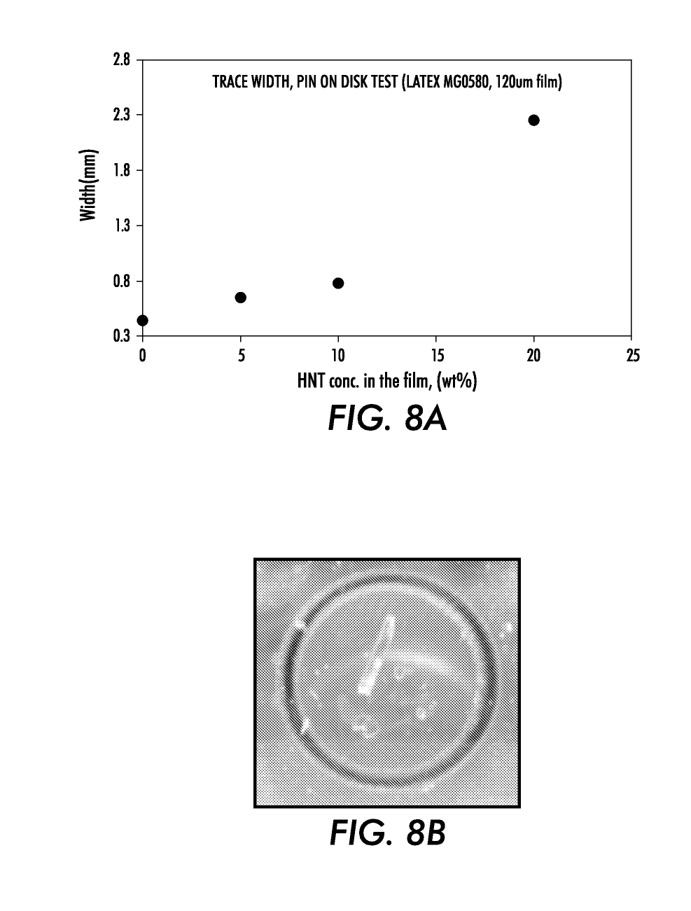

FIG. 8A is an illustration of the test results from various HNT concentrations in the MG-0508 0580 latex composite prepared as described above. More specifically, FIG. 8A illustrates the measurements of the trace width, for example of the sample depicted in the photograph of FIG. 8B, whereby the width of the trace resulting from the pin (314) of FIG. 3A is indicative of an increasing modulus as HNT loading is increased. The pin-on-disk trace width for 0, 5, 10, and 20% HNTs in MG-0580 is depicted.

As will be appreciated by an observation of the results depicted in FIGS. 4-8A, increasing the content of the HNTs in the films increased both the elastic or storage (G′) and loss (G″) modulus by an order of magnitude over the HNT range, up to 20 wt-%, relative to comparative example 1 (coating without HNTs) (FIGS. 4 and 5). The results with Comparative Example 1B (platy clay) actually show a reduction in G′ and G″, clearly showing the advantage of the HNT-containing coating. The pin-on-disc measurements (FIG. 8) provide evidence consistent with an increasing modulus as HNT loading is increased.

Tackiness of the composite films against a glass substrate was generally maintained as HNT loading was increased to 20%, as depicted in FIG. 6. Tackiness of the composite films against a polyethylene (PE) substrate, as depicted in FIG. 7, increased up to the level of 10% loading and then dropped off.

As is clear from FIG. 1, halloysite nanotubes 12 were well dispersed within the films, with individual and small clusters of halloysite nanotubes observed to be scattered along the domains of the individual latex particles 10. As previously mentioned relative to FIG. 1, the halloysite nanotubes 12 are scattered along, and in several cases also span, the domain boundaries of the latex particles.

The amount of nanotubular clay filler dispersed in the polymer composition, based on the total weight of polymer, is believed to be preferably between about 1 and about 20 percent, and more preferably between about 5 percent and about 15 percent and, as indicated in the embodiment described above, about 10 percent—the nanoclay filler including halloysite or a similar but alternative mineral nanotube material, having an outer tube or cylindrical diameter of less than about 500 nm and a length of less than about 40,000 nm (40 um).

As a result of the testing set forth in Example 1 and Comparative Example 1A, it is clear that the introduction of between about 1 to about 20 weight-percent, or about 5 to about 15 weight-percent, and perhaps more preferably about 10 weight-percent of a filler comprising or consisting essentially of treated halloysite clay nanotubes produces an increase in the modulus of the nanocomposite adhesive, without sacrificing adhesive strength. Moreover, the properties are at least as good, and appear to be significantly improved as compared to a similar platy clay nanocomposite, albeit avoiding the added complexity and cost of preparing the platy clay filler material (i.e., avoiding exfoliation processing).

Although described above as a general casting method, it will be appreciated that various methods for the application of the resultant polymeric adhesive nanoparticle composite coating may be employed. Examples of coating and other application methods include but are not limited to brush, or similar tool, coating, roller coating; die coating; bead coating; dip coating; spray coating, print coating (e.g., ink-jet and related patterned dispensing techniques) and other non-contact methods; screen printing, curtain coating, and solid-film coating. Additional techniques and processes may be employed to apply the disclosed composite to various surfaces or substrates, including slide bead coating, slot coating, knife or blade metering, free jet coating, rod metering, casting, non-contact coating (including application via non-contacting printing techniques so as to selectively coat certain areas of a substrate and not others), metered film press coating, air knife coating, gravure coating and powder coating. As noted such processes may be used to coat entire surfaces or may be selectively applied and/or masked so as to control the application of the coating to a portion of a surface or substrate.

### EXAMPLES 2 AND 3

Halloysite premium EG, obtained from Nanoclays and Technologies, Inc and KC Kaolin, a mixture of halloysite and kaolin clays obtained from i-Minerals were separately dispersed into a low-T_{g} Rohm and Haas acrylic copolymer latex, Roderm MD 5600 (T_{g}=−30C) at about 10% weight percent solids of the clay. Roderm MD 5600 is one of a number of acrylic adhesives, or more specifically aqueous pressure sensitive adhesives available from Rohm and Haas.

Preparation of the Halloysite Coating Solutions

The MD 5600 latex (55% solids) was diluted with de-ionized water in an amount such that the total percent solids of the final experimental coating solutions were approximately 50% solids. The mixing head of a Model SPX Premier Mill Laboratory Dispersator was inserted into the diluted latex and brought to 4500 rpm. The halloysite containing powder (Example 2 used Halloysite EG; Example 3 used KC Kaolin) was added in small portions into the stirring latex in order to produce a clay loading of about 10% by weight. When all the powder was added, the blend continued to stir for 5 min. The dispersion was then degassed under reduced pressure at room temperature.

Preparation of the Adhesive Coatings

A sheet of 4 mil clear PET was placed onto a heated coating block. A 10 mil wet laydown, drawdown hopper was placed on the PET sheet and filled with the coating solution. The drawdown hopper was pulled down the sheet at a uniform speed and pulled off. The coating was dried on the 120° F. coating block.

### Comparative Example 2A

Comparative Example 2A was prepared in a manner consistent with Examples 2 and 3 above, but without any clay added. Coatings were prepared as in the manner set forth for Examples 2 and 3.

### Comparative Example 2B

Comparative Example 2B was prepared in a manner consistent with Examples 2 and 3 above, but with about 10 weight % Veegum T (smectic clay from Vanderbilt Co. Inc.) used in the place of the halloysite clays. The coating solution was not stable and immediately aggregated. Work on this sample was not continued. No coatings were prepared.

### Comparative Example 2C

Comparative Example 2C was prepared in a manner consistent with Examples 2 and 3 above, however with about 10 weight % Bentonite clay in the place of the halloysite clays. Coatings were prepared as for Examples 2 and 3.

Preparation of Adhesion Samples

The films of Examples 2 and 3, as well as the comparative examples in which stable coating solutions were obtained, as described above, were cut into strips that are approximately 25.4 mm wide and approximately 88 mm long such that a 50.8 mm length of the adhesive coating was available at one end. A 25.4 mm by 88 mm strip of uncoated 4 mil thick PET was aligned on top of the coated film strip and the films were laminated together by applying pressure. Pressure was applied by rolling a 2 Kg elastomer coated steel roller, rolled across the sample ten times. This preparation process yields a test strip that has a full width adhesion area about 50.8 mm long. The unadhered ends of the strips lie on top or apposed with one other and may be easily separated for use as a T-peel specimen. The laminated samples were rested overnight.

Adhesion Test

The unadhered ends of the respective films were separated from one another and inserted, respectively, into the upper and lower clamps of a Tinius Olsen T-Series model H5KT, 5 KNewton load cell, HW20 wedge grips in the manner of a T-peel specimen. With the unadhered ends of the test sample secured tightly, the clamps are then separated at a constant rate of speed and the force necessary to peel the two strips of PET apart in the adhered area was measured. The tests were run at room temperature and the crosshead speed was 304.8 mm/min. The test was ended as the end of the adhesive patch was reached. Results were reported for the steady state force required to separate the strips in the central area of the adhesive patch. Three replicates were run and averaged for each sample tested.

Adhesion Test Results

The peel force was determined as an average of the force required to separate a central area of the 50.8 length of the adhesive patch. The test results are set forth in Error! Reference source not found. After the peel, the two strips were examined to determine the adhesive failure mode.

Both Examples 2 and 3 contained halloysite and exhibited stronger peel strength than the unfilled acrylic latex of Comparative Example 2A. Example 2, with only halloysite, had a higher adhesive strength in this test than Example 3, which contained some non-halloysite clay. The failure mode for Examples 2 and 3 as well as Comparative Example 2A was cohesive, meaning that the adhesive bond failed within the adhesive, thereby allowing some material to be transferred to the originally uncoated PET strip. In all cohesive failure cases an adhesive bond was readily reobtained by pressing the two sheets back together.

Comparative Example 2C produced an adhesive bond that was inferior to the latex itself and to Examples 2 and 3. The failure was at the surface of the uncoated PET strip. There was no material transfer. As a result of the testing, it is believed that the use of the Halloysite as an additive is likely to increase the adhesion of the adhesive composite.

TABLE A

| | Average | Failure |
|---|---|---|
| Sample | Strength (N) | Mode |
| Example 2 (10% Halloysite) | 31.8 | cohesive |
| Example 3 (10% KC Kaolin) | 28.0 | cohesive |
| Comparative Example 2A (No Clay) | 26.9 | cohesive |
| Comparative Example 2B (10% | N/A | N/A |
| Veegum T; incompatible) | | |
| Comparative Example 2C (10% | 4.1 | adhesive to |
| Bentonite) | | uncoated PET |

Additional and Alternative Embodiments

Moreover, although described above relative to a latex-based adhesive, it is believed that similar results may be achieved with non-latex based adhesives employing HNTs, such as hot melts (e.g., ethylenevinylacetate) containing HNTs and also “superglue-type” (e.g., cyanoacrylate) adhesives containing HNTs. It is recognized that such adhesives may require alternative techniques for the formation or dispersion of the HNTs in a non-waterborn adhesive. Moreover, it is further contemplated that the HNTs may be included in an emulsion polymerization step, whereby the latex particles themselves are composites with HNTs, and that films, membranes, or other useful material forms may be made therefrom.

In further embodiments it is contemplated that the halloysite or other inorganic nanotubular materials may be treated and/or may include one or more active agents (coated on or encapsulated or otherwise present within the interior of the tubular structure). With respect to the treatment, or more particularly surface treatment, it is contemplated that halloysite nanotubes, for example, may be treated using one of the compatibilization agents disclosed herein (e.g. organosilanes). As noted with respect to the results of Example 1, the compatibilization agents are anticipated to provide even greater improvements in the mechanical properties of the nanocomposites in which they are employed. An alternative group of agents, or active agents, are intended to provide a desired effect as a result of their use or delivery using the nanotubes.

Compositions of the various embodiments may include one or more additives or active agents. Those skilled in the art will recognize, with the benefit of this disclosure, that a number of additives may be useful in an embodiment. Additives may include, as described above, one or more colorants, antioxidants, emulsifiers, biocides, antifungal agents, pesticides, fragrances, dyes, optical brighteners, fire retardants, self-healing polymers and plasticizers (e.g. as described in U.S. patent application Ser. No. 11/469,128 for “POLYMERIC COMPOSITE INCLUDING NANOPARTICLE FILLER,” by Cooper et al., filed Aug. 31, 2006, and related Provisional Application 60/728,939 both of which are hereby incorporated by reference in their entirety) or mixtures and combinations thereof. The amount of the additive necessary will vary based upon the type of additive and the desired effect.

The ratio of the active agent to nanotubular filler, for example inorganic (mineral-derived) nanotubes, may be varied to provide differing levels of efficacy, release profile, and distribution. For example, the compositions may include an approximate ratio of active agent to nanotubular material (by weight) of between 1:1 and 5:1, however ratios in the range of about 1×10⁻⁵:1 to about 10:1 may provide the desired effect. In this embodiment, nanotubular filler without additives may be employed for improved physical properties together with one or more nanotubular fillers compositions which are include active agents.

In one contemplated embodiment, compositions may provide an active agent or a plurality of active agents in an extended release profile and/or a controlled release profile. For example, the active agent may provide the desired effect in the nanocomposite for weeks, months or even years. It is understood that the release rate may be a function of the solubility of the active agent in its carrier or the composite matrix and/or the mobility/diffusion thereof within the composite. For example, an adherent barrier coating may be employed for retarding or controlling the release rate. Moreover, it is contemplated that a plurality of active agents may be included in a combination of extended and controlled release profiles to achieve a single or perhaps multiple effects. In addition, compositions may be blended to enhance active agent properties.

In yet an additional contemplated embodiment, compositions and methods may also be employed to enable the distribution of one or more active agents, including the distribution of agents at one or more rates and/or at one or more times. The composition may include, for example, mineral-based nanotubular material having one or more active agents and additives. The active agents may be selected from the list of active agents set forth above, or other agents, and combinations thereof. For example, an inorganic nanotubular composition may be created to distribute one active agent at a first rate and a second active agent at a second rate, and more particularly, where the first rate is greater than the second rate. As will be appreciated, the foregoing embodiments are intended to be exemplary and are not intended to limit the various embodiments described herein or otherwise incorporating the inventive concepts disclosed.

Another embodiment may further include the method of encapsulating the active agent within the nanotubular structures of halloysite or similar inorganic materials. In the embodiment, as disclosed for example by Price at al. in U.S. Pat. No. 5,492,696, and hereby incorporated by reference in its entirety, the nanotubes are cylindrical microstructures and may have been pre-treated by metal cladding or coating using an electroless deposition process. Next, the nanotubes are air or freeze dried to provide hollow microcapillary spaces. The micro-capillary spaces are subsequently filled by exposing the dried nanotubes to the active agent and its carrier or solvent, wherein the active agent is allowed to infiltrate (e.g., scattering spreading, injecting, etc.) Post processing of the filled nanotubes may include filtering or other processes to remove the active agent/carrier from the outer surfaces of the nanotubes, or to provide a secondary exposure to permit extended or controlled release of the active agent once the nanotube filler material has been used in the preparation of a nanocomposite material.

As suggested above, at least one embodiment contemplates the use of a post-infiltration coating that may act as a cap or plug to moderate the release of the active agent. In other words, the polymer composition may further include an adherent barrier coating, applied to the nanotubes, for controlling the release of the active agent from the nanotubes. Similar techniques are also disclosed, for example, by Price et al. in U.S. Pat. No. 5,651,976, which is hereby incorporated by reference in its entirety, where a biodegradeable polymeric carrier is encapsulated within the microcapillary space of the nanotube.

Other possible applications for the use of halloysite nanotubes in an adhesive nanocomposite include: fire retardant coatings; anti-corrosion coatings; self-cleaning surfaces; self-healing plastics; barrier coatings; optical coatings and paints; biodegradable coatings; anti-microbial coatings; and high temperature coatings. In the foregoing embodiments, the halloysite may be used in crude or refined form. As used herein the term crude form halloysite refers to halloysite that is substantially unrefined (e.g., halloysite ore, with little or no further processing or refinement of the halloysite, per se). On the other hand, refined halloysite refers to processed halloysite where the nanotube content has been artificially increased by any of a number of processing and separation technologies. High nanotube content refined halloysite is particularly useful in the foregoing applications in view of its high strength to weight ratio (e.g., for structural reinforcement and for high loading capacity). As illustrated in the examples above, use of the halloysite nanotube clay as a filler in the nanocomposite material provides, at a minimum, improved resistance to thermal decomposition while maintaining or improving the mechanical properties of the composite as compared to the raw polymer. It is further contemplated that while various examples are set forth herein for acrylic and similar adhesives, thermosetting materials and thermoresins may also find particular use with the halloysite nanotubular fillers described herein.

Furthermore, the high surface area within the nanotubes permits slow and consistent dissolution or elution of materials loaded within the nanotube. This feature of the nanotube permits the fabrication of materials having surprising endurance and long life even under extremely harsh conditions (e.g., high temperature, high moisture, low and/or high pressure, high and/or low pH, etc.). Further, the tubes could also slowly or quickly absorb/adsorb substances. A point of note is that the HNTs do not have a particularly high surface area compared with delaminated platy clays, but are expected to retain a reasonably large surface area upon incorporation into latexes, since the latex particles will not enter the tubes. Therefore, the inner surfaces of the tubes will at least be free of latex particles, to a large extent, provided the latex particles are larger than the tube opening diameter.

Further contemplated are various gels as set forth above. Also contemplated is the use of liquid crystal polymer composites with HNTs. Embodiments of such composites may include, but are not limited to, aromatic polyesters based on p-hydroxybenzoic acid and related monomers. Some commercial examples Vectran® from Hoechst Celanese; DuPont™ Zenite®, Xydar®—from Solvay, where such materials may be pre-blended with minerals and other fillers.

As a result of the examples and results set forth above, it is contemplated that one application of the disclosed materials may be using the tube-filled latex in low amounts as a binder in high solids films (e.g., paper coats). The rising costs of latex sourced from fossil fuels places incentives on paper coating manufacturers to lower the latex content of their coats. Latex is used in paper coats as, among other things, a binder for pigments such as calcium carbonate. It may be envisaged that the amount of latex could be reduced in paper coats without compromising the physical and mechanical properties of the coating or coated paper by addition of halloysite and at the same time achieving additional benefits associated with the tubular pore spaces in the tubes—such as enhanced moisture control, enhanced printability, containment, capture or release of actives (optical brightening agents, anti-yellowing agents, perfumes, antimicrobials, sizing agents, fire retardants, indicators, etc.) Alternative polymeric binders used in paper and paper coatings such as thermosets and thermoplastics could also benefit from compositing with halloysite nanotubes because of the previously disclosed benefits—in other words, enhanced mechanical strength potential to lower the amount of polymers used, combined with the additional functionality of the hollow nanotube already stated. Such polymers could include dendrimeric polymers, nanoparticulate plastics that are subsequently fused by a heating step, and those thermosets, thermoplastics, biopolymers and other materials previously set forth herein or as known similar or substitute materials.

Other possible applications of the disclosed materials and methods may be achieved through the compositing of HNTs with other composite coatings and/or adhesives. For example, a material containing HNT may be composited further with carbon fiber/epoxy resins, etc. or with glass fiber/glues. In these composited materials, it is believed that because the halloysite is operative at a nano-micron scale and the carbon or glass fiber is operative at longer length scales, significant combined advantages may be achieved. As one example, the carbon or glass fiber material may obtain the added characteristics and advantages arising from the use hollow HNTs, as described herein, where the HNTs may release resin curing accelerators, flattening agents, etc. Such embodiments may not only improve the characteristics of the composited material, but may also make it possible to achieve improved applicability.

A further embodiment could be other paper coatings including those polymeric adhesives where the advantages set out previously for polymer and halloysite nanotube composites also apply for their use in polymer coated papers. Furthermore, the polymer-HNT nanocomposites may improve the binding quality of the paper or paper coats, paperboard, carton, and other products that have paper or paperboard as an intrinsic part. For example, gypsum board is held together with paper layers like a sandwich.

Although several of the disclosed embodiments are directed to halloysite nanotubes and related clay materials, various aspects and features of the disclosed embodiments may also be achieved with alternative filler materials, some of which also exhibit similar tubular structures, and such materials are also contemplated as alternatives herein. Examples of the alternative nanotubular fillers include: other tubular 1:1 sheet silicates, and particularly those having effective area mismatches per charge in apposed octahedral and tetrahedral layers (e.g., other than halloysite); tubular double-layer hydroxides with effective area mismatches per charge in apposed octahedral and tetrahedral layers; metal sulfides, selenides and tellurides that can form tubes including, but not limited to, MOS₂, WS₂, TaS₂, NbS₂, ReS₂, etc.; surfactant templated silica nanotubes; metal silicate nanotubes; metal aluminosilicate nanotubes; metal germanate nanotubes; sulfosalts such as cylindrite and boulangerite; metal oxide and hydroxides, including those with a tubular shape; boron-containing nanotubes such as BCN and boron nitride; and organic nanotubes.

It will be appreciated that various of the above-disclosed embodiments and other features, applications and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. An adhesive, comprising:
a polymer; and
a nanotubular filler, wherein said polymer and said nanotubular filler, in combination, form a polymeric nanoparticle adhesive.

2. The adhesive of claim 1, wherein the nanotubular filler includes halloysite nanoparticles.

3. The adhesive of claim 2, wherein said halloysite nanoparticles have a generally tubular shape.

4. The adhesive of claim 1, wherein said polymer includes a latex-based adhesive.

5. The adhesive of claim 1, wherein said adhesive material is selected from the group consisting of:
thermoplastics;
thermosetting plastics; and
elastomers.

6. The adhesive of claim 1, wherein said polymer includes latex polymer.

7. The adhesive of claim 1, wherein said nanotubular filler further includes at least one compatibilization agent.

8. The adhesive of claim 7, wherein said compatibilizing agent includes a quaternary ammonium salt.

9. The adhesive of claim 7, wherein said compatibilizing agent includes an organosilane.

10. The adhesive of claim 2, wherein said composite exhibits a storage modulus greater than that of said polymer without filler.

11. The adhesive of claim 2, wherein said composite exhibits an adhesion force greater than that of said polymer without filler.

12. The adhesive of claim 1, wherein said nanotubular filler includes particles having a generally scroll-like shape and that exhibit differential surface charges to form a localized network of tubes arranged generally end to wall.

13. The adhesive of claim 1 wherein the composite is in the form of a coating applied to at least one surface.

14. The adhesive of claim 1, wherein said nanotubes include at least one agent for elution.

15. The adhesive of claim 14, wherein said agent for elution is selected from the group consisting of: biocides; minerals; light emitting substances; fluorescent substances; phosphorescent substances; colorants; antioxidants; emulsifiers; antifungal agents; pesticides; fragrances; dyes; optical brighteners; fire retardants; self-healing polymers; and combinations thereof.

16. The composite of claim 1, wherein the nanotubular filler is selected from the group consisting of:
imogolite;
cylindrite; and
boulangerite.

17. The composite of claim 1, wherein the nanotubular filler is selected from the group consisting of:
tubular 1:1 sheet silicates, including those with effective area mismatches per charge in apposed octahedral and tetrahedral layers;
tubular double layer hydroxides, including those with effective area
mismatches per charge in apposed octahedral and tetrahedral layers;
tubular metal sulfides;
tubular metal selenides tubular metal tellurides;
surfactant templated silica nanotubes;
metal silicate nanotubes;
metal aluminosilicate nanotubes;
metal germanate nanotubes;
tubular metal oxide;
tubular metal hydroxides;
boron-containing nanotubes; and
organic nanotubes.

18. A method for making a polymer nanocomposite adhesive, including:
producing a milled material having a nanotubular particle structure; and
combining an adhesive polymer with said milled material to form the polymer nanocomposite adhesive.

19. The method of claim 18, wherein combining an adhesive polymer with said milled material includes introducing the nanotubular particle filler during the emulsion polymerization step of latex preparation.

20. The method of claim 19, wherein latex particles are employed and said latex particles are themselves composites including halloysite nanotubes therein.

21. The method of claim 18, where producing a milled material comprises air milling the nanotubular particles.

22. The method of claim 18, further including drying said milled material prior to combining.

23. The method of claim 18, further including surface modifying the milled material.

24. The method of claim 23 where the surface modifying agent is an organosilane.

25. The method of claim 18, further including forming the nanocomposite adhesive coating using a manufacturing process selected from the group consisting of:
roller coating;
die coating;
bead coating;
dip coating;
spray coating;
casting;
non-contact coating;
screen printing;
curtain coating; and
solid-film coating.

26. The method of claim 24, wherein the milled material is halloysite and where surface modifying said halloysite material includes exposing said halloysite material to benzalkonium chloride in the range of about 0.1 percent to about 2.0 percent.

27. The method of claim 18, further including exposing said material to a compatibilization agent.

28. The method of claim 27, wherein said compatibilization agent includes an organic compound.

29. The method of claim 28, wherein said organic compound is selected from the group consisting of: neutral and ionic compounds.

30. The method of claim 27, wherein said compatibilization agent includes an inorganic compound.

31. The method of claim 30, wherein said inorganic compound is selected from the group consisting of: neutral, ionic and zwitterionic compounds.

32. The method of claim 27, wherein said compatibilization agent is selected from the group consisting of: organosilane; organozirconate; and organotitanate agents.

33. The method of claim 18, wherein said milled material is combined with said polymer to produce a composite including a range of about 1 to about 20 weight-percent milled material.

34. The method of claim 18, wherein said milled material is combined with said polymer to produce a composite including a range of about 5 to about 15 weight-percent milled material.

35. The method of claim 18, wherein said milled material is combined with said polymer to produce a composite including about 10 weight-percent milled material.

36. The method of claim 18, further including adding at least one additive selected from the group consisting of: colorants, antioxidants, emulsifiers, biocides, antifungal agents, pesticides, fragrances, dyes, optical brighteners, self-healing polymers and plasticizers, and fire retardants.

37. The method of claim 18, further including:
coating the milled material with a metal;
drying the coated milled material to provide hollow micro-capillary spaces; and
filling the micro-capillary spaces by exposing the dried milled material to an active agent and the agent's carrier or solvent.

38. The method of claim 18, further including compositing the polymer nanocomposite adhesive with another material.
